(19) United States
(12) Patent Application Publication
(10) Pub. No.: US 2024/0202082 A1
(43) Pub. Date: Jun. 20, 2024

(54) EVENT-DRIVEN USER-BASED PRIMARY DEVICE SELECTION

(71) Applicant: T-MOBILE INNOVATIONS LLC, Overland Park, KS (US)

(72) Inventors: Raymond Emilio Reeves, Oviedo, FL (US); Simon Youngs, Overland Park, KS (US); Mark Peden, Paola, KS (US)

(21) Appl. No.: 18/085,254

(22) Filed: Dec. 20, 2022

(51) Int. Cl. G06F 11/20; G06F 11/07

(52) U.S. Cl. CPC G06F 11/2007; G06F 11/0742

(57) ABSTRACT

According to aspects herein, methods and systems for event-driver user-based primary device selection are provided. The method begins with receiving an indication of an imminent UE failure event from at least one UE, wherein the UE is a member of at least one primary device selection cluster. The primary device selection manager then identifies at least one replacement primary device to take over for the at least one UE wherein the at least one replacement primary device is a member of the at least one primary device selection cluster. A notification containing a selection of potential replacement primary devices is transmitted to the at least one UE. A user may select at least one replacement primary device from the selection in the notification and transmit that selection to the primary device selection manager.

### BACKGROUND

Users are increasingly reliant on mobile devices for many daily activities with many mobile devices in constant or near-constant use. Such use not only affects battery power consumption, it may cause the mobile device to become hot. In some cases, the mobile device may reach a critical temperature threshold. When this occurs, the mobile device deregisters from the network and powers off. The network may then identify whether the user has another device which may be used in place of the powered off device. The powered off device may be known as the primary device and a user's other devices may be used as the primary device when the primary device is unavailable. The decision to use another device may be made by the network. Similarly, the selection of a new primary device may also be made by the network, not the user. At present, a user has no input into which device may become the primary device. The network may look for another user equipment (UE) and select that UE as the primary device, while the user may prefer to have another device, such as a tablet or laptop become the primary device.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for event-driver user-based primary device selection are provided. The method begins with receiving an indication of an imminent UE failure event from at least one UE. The UE is a member of at least one primary device selection cluster. The primary device selection manager then identifies at least one replacement primary device to take over for the at least one UE with the at least one replacement primary device a member of the at least one primary device selection cluster. After identifying at least one replacement primary device, a notification containing a selection of potential replacement primary devices is transmitted to the at least one UE. The user of the at least one UE then selects at least one replacement primary device selected from the selection of replacement primary devices and transmits that selection to the primary device selection manager.

In a further embodiment, a method for event-driver user-based primary device selection is provided. The method begins with a determination by a UE that failure of the UE is imminent. The UE may be a member of at least one primary device selection cluster. The UE then transmits to a primary device selection manager an indication of the imminent failure of the UE. The method continues with the failing UE receiving a notification containing a selection of potential replacement primary devices. The user of the failing UE selects a replacement primary device from the selection of potential replacement primary devices and transmits the selection to the primary device selection manager.

An additional embodiment provides a non-transitory computer storage media storing computer-useable instructions that, when executed by one or more processors cause the processors to receive an indication of an imminent UE failure event from at least one UE. The at least one UE experiencing the failure event may be a member of at least one primary device selection cluster. The processors then identify at least one replacement primary device to replace the failing UE. The replacement primary device may be a member of the at least one primary device selection cluster. A notification is then transmitted to the at least one UE, wherein the notification contains a selection of potential replacement primary devices. A selection of at least one replacement primary device selected from the selection of replacement primary devices in the notification is received from the at least one UE.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 is a flow diagram of an exemplary method for event-driver user-based primary device selection in an exemplary network environment, in which aspects of the present disclosure may be employed; and

FIG. 4 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., nodes, cell sites, cell towers) to provide network coverage. The base stations are employed to broadcast and transmit transmissions to user devices of the telecommunications network. An base station may be considered to be a portion of a base station that may comprise an antenna, a radio, and/or a controller. In aspects, a base station is defined by its ability to communicate with a user equipment (UE), such as a wireless communication device (WCD), according to a single protocol (e.g., 3G, 4G, LTE, 5G, or 6G, and the like); however, in other aspects, a single base station may communicate with a UE according to multiple protocols. As used herein, a base station may comprise one base station or more than one base station. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

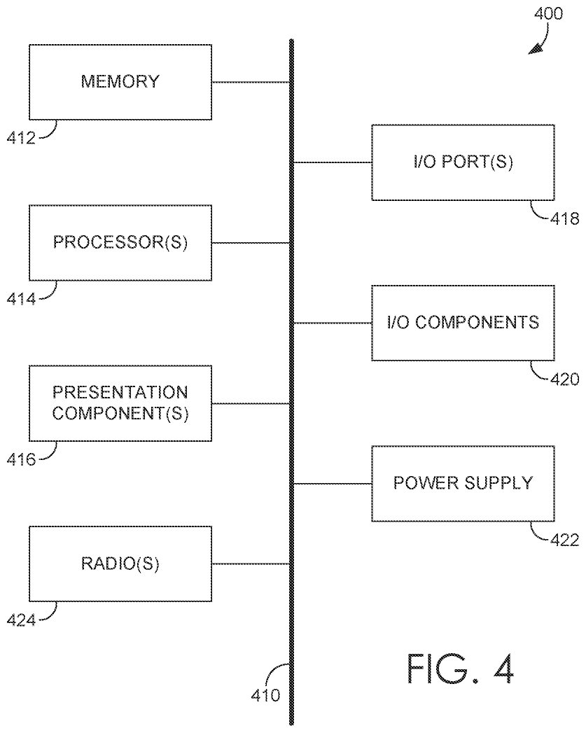

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to computing device 400 described herein with respect to FIG. 4.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station.

In aspects, a UE provides UE data including location and channel quality information to the wireless communication network via the base station. Location information may be based on a current or last known position utilizing GPS or other satellite location services, terrestrial triangulation, an base station's physical location, or any other means of obtaining coarse or fine location information. Channel quality information may indicate a realized uplink and/or downlink transmission data rate, observed signal-to-interference-plus-noise ratio (SINR) and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the base station or at the individual antenna array of the base station. In other aspects, the processing of said information may be done remotely.

A service state of the UEs may include, for example, an in-service state when a UE is in-network (i.e., using services of a primary provider to which the UE is subscribed to, otherwise referred to as a home network carrier), or when the UE is roaming (i.e., using services of a secondary provider providing coverage to the particular geographic location of the UE that has agreements in place with the primary provider of the UE). The service state of the UE may also include, for example, an emergency only state when the UE is out-of-network and there are no agreements in place between the primary provider of the UE and the secondary provider providing coverage to the current geographic location of the UE. Finally, the service state of the UE may also include, for example, an out of service state when there are no service providers at the particular geographic location of the UE.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

In accordance with a first aspect of the present disclosure a method for event-driver user-based primary device selection is provided. The method begins with receiving an indication of an imminent UE failure event from at least one UE. The UE is a member of at least one primary device selection cluster. The primary device selection manager then identifies at least one replacement primary device to replace the at least one UE, wherein the at least one replacement primary device is a member of the at least one primary device selection cluster. After identifying at least one replacement primary device, a notification containing a selection of potential replacement primary devices is transmitted to the at least one UE. The primary device selection manager then receives, from the at least one UE, a selection of at least one replacement primary device selected from the selection of replacement primary devices.

A second aspect of the present disclosure provides a method for event-driven user-based primary device selection is provided. The method begins with a determination by a UE that failure of the UE is imminent. The UE may be a member of at least one primary device selection cluster. The UE then transmits to a primary device selection manager an indication of the imminent failure of the UE. The method continues with the failing UE receiving a notification containing a selection of potential replacement primary devices. The user of the UE may select a replacement primary device from the selection of potential replacement primary devices in the notification and transmit that selection to the primary device selection manager.

Another aspect of the present disclosure is directed to a non-transitory computer storage media storing computer-useable instructions that, when used by one or more processors, cause the processors to receive an indication of an imminent UE failure event from at least one UE. The at least one UE experiencing the failure event may be a member of at least one primary device selection cluster. The processors then identify at least one replacement primary device to take over for the failing UE. The replacement primary device may be a member of the at least one primary device selection cluster. A notification containing a selection of potential replacement primary devices is then transmitted to the UE. The user of the UE may select at least one replacement primary device from the selection of replacement primary devices in the notification and transmit that selection to the processors.

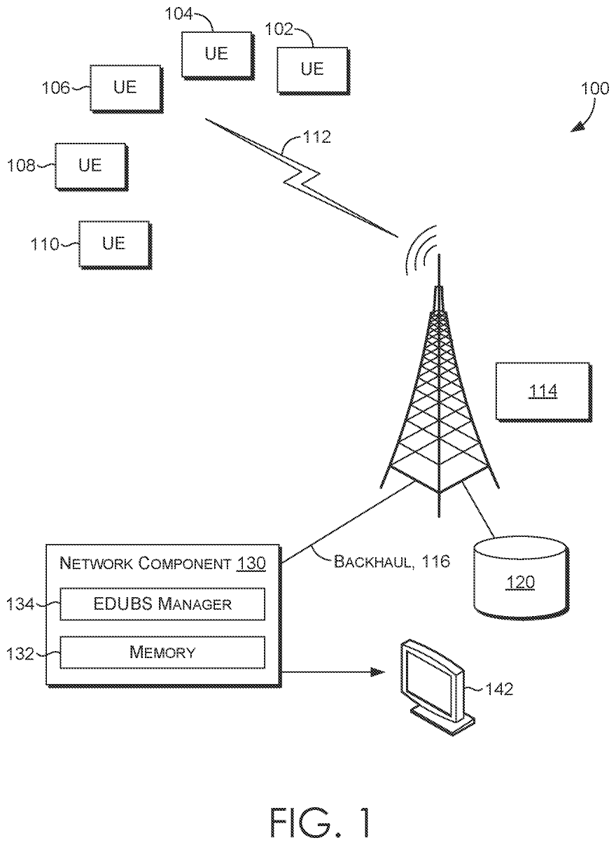

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes UE devices 102, 104, 106, 108, and 110, base station 114 (which may be a cell site or the like), and one or more communication channels 112. The communication channels 112 can communicate over frequency bands assigned to the carrier. In network environment 100, UE devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, an extended reality device, and any combination of these delineated devices, or any other device (such as the computing device (1000) that communicates via wireless communications with the base station 114 in order to interact with a public or private network.

In some aspects, each of the UEs 102, 104, 106, 108, and 110 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, devices such the UEs 102, 104,106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through base station 114. Base station 114 may be a gNodeB in a 5G or 6G network.

The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G network, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), a 5G network or a 6G network.

In some implementations, base station 114 is configured to communicate with a UE, such as UEs 102, 104, 106, 108, and 110, that are located within the geographic area, or cell, covered by radio antennas of base station 114. Base station 114 may include one or more base stations, base transmitter stations, radios, antennas, antenna arrays, power amplifiers, transmitters/receivers, digital signal processors, control electronics, GPS equipment, and the like. In particular, base station 114 may selectively communicate with the user devices using dynamic beamforming.

As shown, base station 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the base station 114. Base station 114 may store the data communicated by the UEs 102, 104, 106, 108, and 110 at a network database 120. Alternatively, the base station 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the base station 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132 and an event-driver user-based primary device selection (EDUBS) manager 134. All determinations, calculations, and data further generated by the EDUBS manager 134 may be stored at the memory 132 and also at the network database 120. Although the network component 130 is shown as a single component comprising the memory 132 and EDUBS manager 134 it is also contemplated that each of the memory 132 and EDUBS manager 134 may reside at different locations, be its own separate entity, and the like, within the home network carrier system.

The EDUBS manager 134 allows authorized users, such as those in a shared plan among friends and family, to define and share UE clusters that may be treated as a community pool of UEs that the EDUBS may present to a user with a failing UE as potential replacement primary devices. The primary device selection cluster may include multiple types of devices, including UEs, tablets, laptops, or other devices. In the event that an EDUBS managed device faces a critical or catastrophic event, which may be thermal limits, performance degradation, or similar event, the UE conveys a notification to the EDUBS manager 134 conveys a notification that a replacement primary device needs to be identified. The EDUBS manager 134 in turn notifies all UECs that the at risk UE may be a cluster member. The EDUBS manager 134 determines potential candidates to serve as the potential replacement primary devices and includes a list of at least one potential replacement primary device in a notification sent to the subscriber. A subscriber may preselect a number of potential replacement primary devices and convey that information to the EDUBS manager 134. The subscriber may also elect to have the EDUBS manager 134 make the selection of a replacement primary device.

The network component 130 is configured to retrieve signal information, UE device information, slot configuration, latency information, including quality of service (QOS) information, and metrics from the base station 114 or one of the UE devices 102, 104, 106, 108, and 110. The information may also include RF signal quality information, such as signal to interference and noise (SINR) ratio. UE device information can include a device identifier and data usage information. The information stored in memory 132 may be used by the antenna tilt module 134.

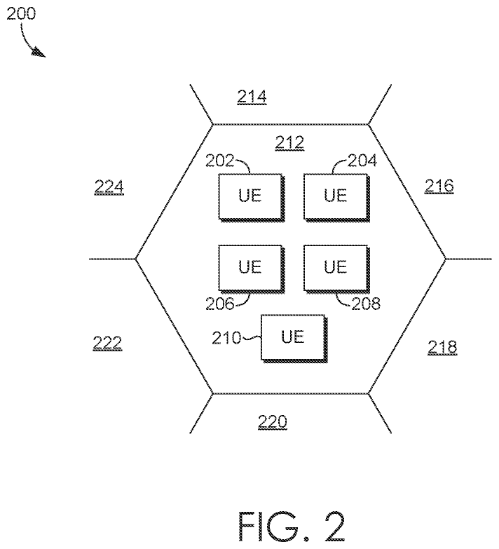

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cells 212, 214, 216, 218, 220, 222, 224, each including base station or base station 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

The EDUBS system provide for users to define and share UE clusters (UECs), that may be treated as a community pool of UEs. The UEC may be formed by a group of users, such as a family, or set of friends, or business associates. If a UE is facing a critical or catastrophic event, such as a thermal limit, performance degradation, or similar event, the UE sends a notification to the EDUBS manager 134. The notification sent by the UE may include details of neighboring UEs and UECs. Upon receipt of the notification the EDUBS manager 134 identifiers the UECs that the failing UE may be a member of and determines multiple candidates and at least one best candidate to serve as a replacement primary UE. The EDUBS manager 134 may consider multiple factors, including: location, accessibility, RF health, and microservice profiles for the potential replacement primary UE. The user is notified of the need to select the replacement primary UE.

The failing UE may also send a peer-to-peer notification through an available network to any authorized UEC or directly to a UEC manager. The network may be a near field communication network, a WiFi network, or a cellular network. The peer-to-peer notification allows the failing UE to present secure credentials that allow the UEC or UEC manager to take over future communications based on the predefined criteria. The predefined criteria may include: micro-services, UE capabilities and/or policy for the role change. Parental access, fleet managers and public service administrators may need to ensure that all communications are visible and attended to without disruption. Once the UEC manager presents valid credentials or the UE owner approves the temporary transfer of service, all future communications are sent to the newly approved replacement primary UE until the original primary UE is available.

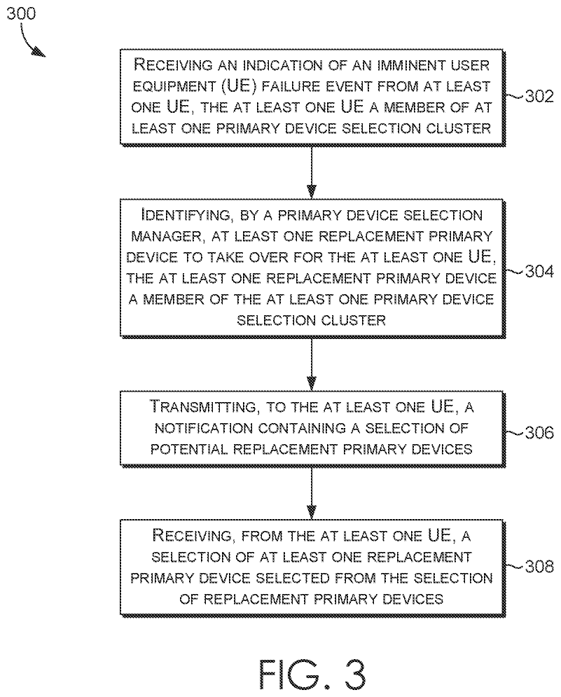

FIG. 3 is a flow diagram of an exemplary method for event-driver user-based primary device selection in an exemplary network environment, in which aspects of the present disclosure may be employed, in accordance with aspects herein. At block 302 an indication is received of an imminent UE failure event from at least one UE. The at least one UE is a member of at least one primary device selection cluster. The imminent UE failure may be one of multiple types of failures. A common UE failure is failure due to overheating, which may occur when a device is left in strong sunlight or is heavily used for a relatively long period of time. Other failure modes may include failure of a UE display, loss of a speaker, or loss of data connectivity due to device issues. The methods described herein may be used when any type of UE device failure or loss of capacity occurs.

At block 304 a primary device selection manager identifies, at least one replacement primary device to replace the at least one UE, with the at least one replacement primary device being a member of a primary device selection cluster. The primary device selection cluster may comprise other devices associated with the user of the at least one UE, such as tablets, laptops, or another UE. The UE user may define the cluster and may change the cluster definition as circumstances change. For example, a user may receive an indication if imminent UE failure while in a meeting. The user may trust colleagues seated near them and may respond to the failure indication with devices that could serve as a replacement primary device. In another situation, a user may have been heavily using the UE while traveling with friends. The network may have noticed that multiple UEs from subscribers are traveling together and may suggest nearby friends' devices as potential replacement primary devices. The network may form an ad hoc mega-cluster of UEs to serve as the primary device selection cluster.

At block 306 a notification is transmitted to the at least one UE, where the notification contains a selection of potential replacement primary devices. The UE user then selects a replacement primary device from the notification. At block 308 a selection of at least one replacement primary device is received from the at least one UE. The replacement primary device may belong to a user's parent, fleet manager, service manager, or safety personnel. The notification may allow a UE user to indicate which services to transfer for a designated period of time. The selection of the replacement primary device may also incorporate shared codes or other security mechanisms used to ensure both device owners agree to the use of the replacement primary device. The notification may be provided to the UE user with sufficient time to allow the selection and approval of a replacement primary device before UE failure occurs.

The period of time the replacement primary device serves in that role may vary based on the original UE user's usage patterns. A network implementing this mechanism may elect to implement a machine learning system that over time learns UE users' patterns of use. Some users may play more games, with higher processor and display usage times that may decrease battery life. This pattern may change over time and may influence which primary device selection clusters are presented to users in the notification when the UE may fail. The period of time may also be selectable by the user of the failing UE.

FIG. 4 depicts an exemplary computing device suitable for use in implementations of the present disclosure, in accordance with aspects herein. With continued reference to FIG. 4, computing device 400 includes bus 402 that directly or indirectly couples the following devices: memory 404, one or more processors 406, one or more presentation components 408, input/output (I/O) ports 412, I/O components 410, radio 416, transmitter 418, and power supply 414. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 410. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. Memory 404 may be removable, nonremovable, or a combination thereof. Exemplary memory includes solid-state memory, hard drives, optical-disc drives, etc. Computing device 400 includes one or more processors 406 that read data from various entities such as bus 402, memory 404 or I/O components 410. One or more presentation components 408 present data indications to a person or other device. Exemplary one or more presentation components 408 include a display device, speaker, printing component, vibrating component, etc. I/O ports 412 allow computing device 400 to be logically coupled to other devices including I/O components 410, some of which may be built into computing device 400. Illustrative I/O components 410 include a microphone, joystick, game pad, satellite dish, scanner, printer, wireless device, etc.

The radio 416 represents one or more radios that facilitate communication with a wireless telecommunications network. While a single radio 416 is shown in FIG. 4, it is contemplated that there may be more than one radio 416 coupled to the bus 402. In aspects, the radio 416 utilizes a transmitter 418 to communicate with the wireless telecommunications network. It is expressly conceived that a computing device with more than one radio 416 could facilitate communication with the wireless telecommunications network via both the first transmitter 418 and an additional transmitters (e.g. a second transmitter). Illustrative wireless telecommunications technologies include CDMA, GPRS, TDMA, GSM, and the like. The radio 416 may additionally or alternatively facilitate other types of wireless communications including Wi-Fi, WiMAX, LTE, 3G, 4G, LTE, 5G, 6G, NR, VOLTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even base stations (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of event-driven primary device selection in a network, the method comprising:
receiving an indication of an imminent user equipment (UE) failure event from at least one UE, wherein the at least one UE is a member of at least one primary device selection cluster;
identifying, by a primary device selection manager, at least one replacement primary device to replace the at least one UE, wherein the at least one replacement primary device is a member of the at least one primary device selection cluster;
transmitting, to the at least one UE, a notification containing a selection of potential replacement primary devices; and
receiving, from the at least one UE, a selection of at least one replacement primary device selected from the selection of replacement primary devices.

2. The method of claim 1, wherein the imminent UE failure event is a critical temperature event.

3. The method of claim 1, wherein the imminent UE failure event is a performance degradation event.

4. The method of claim 1, wherein the indication of an imminent UE failure includes identification of at least one neighboring UE.

5. The method of claim 1, wherein the indication of an imminent UE failure includes identification of at least one neighboring primary device selection cluster.

6. The method of claim 1, further comprising notifying, by the primary device selection manager, at least one neighboring UE of the imminent UE failure event.

7. The method of claim 1, further comprising notifying, by the primary device selection manager, at least one neighboring primary device selection cluster of the imminent UE failure event.

8. The method of claim 1, wherein identifying at least one replacement primary device is based on at least one of: location, accessibility, radio frequency (RF) health, and microservice profile.

9. The method of claim 1, wherein the selection of replacement primary devices includes at least one of: other devices associated with the user of the at least one UE, previously identified devices approved by the user of the at least one UE, or nearby devices approved by the user of the at least one UE and owners of the nearby devices.

10. A method of event-driven primary device selection in a network, the method comprising:
determining, by a user equipment (UE), that failure of the UE is imminent, wherein the UE is a member of at least one primary device selection cluster;
transmitting, to a primary device selection manager, an indication of the imminent failure of the UE;
receiving, from the primary device selection manager, a notification containing a selection of potential replacement primary devices; and
transmitting, to the primary device selection manager a selected replacement primary device.

11. The method of claim 10, wherein the imminent UE failure event is a critical temperature event.

12. The method of claim 10, wherein the imminent UE failure event is a performance degradation event.

13. The method of claim 10, wherein the notification of the imminent failure of the UE includes identification of at least one neighboring UE.

14. The method of claim 10, wherein the notification of the imminent failure of the UE includes identification of at least one neighboring primary device selection cluster.

15. The method of claim 10, wherein the replacement primary device is at least one of: another device associated with the user of the UE, previously identified devices approved by the user of the UE, or nearby device approved by the user of the UE and owners of the nearby devices.

16. A non-transitory computer storage media storing computer-useable instructions that, when used by one or more processors, cause the processors to:
receive an indication of an imminent user equipment (UE) failure event from at least one UE, wherein the at least one UE is a member of at least one primary device selection cluster;
identify at least one replacement primary device to take over for the at least one UE, wherein the at least one replacement primary device is a member of the at least one primary device selection cluster;
transmit, to the at least one UE, a notification containing a selection of potential replacement primary devices; and
receive, from the at least one UE, a selection of at least one replacement primary device selected from the selection of replacement primary devices.

17. The non-transitory computer storage media of claim 16, wherein the indication of an imminent UE failure includes identification of at least one neighboring UE or an identification of at least one neighboring primary device selection cluster.

18. The non-transitory computer storage media of claim 16, further comprising notify, by the primary device selection manager, at least one neighboring primary device selection cluster or a neighboring UE of the imminent UE failure event.

19. The non-transitory computer storage media of claim 16, wherein identify at least one replacement primary device is based on at least one of: location, accessibility, radio frequency (RF) health; and microservice profile.

20. The non-transitory computer storage media of claim 16, wherein the selection of replacement primary devices includes at least one of: other devices associated with the user of the at least one UE, previously identified devices approved by the user of the at least one UE, or nearby devices approved by the owner of the at least one UE and owners of the nearby devices.
